(19) United States
(12) Patent Application Publication
(10) Pub. No.: US 2008/0292098 A1
(43) Pub. Date: Nov. 27, 2008

(54) COMMUNICATION SYSTEM AND RECEIVER DEVICE

(75) Inventors: Isao AKIMA, Ogaki (JP); Tatsuya HARA, Chino (JP); Eiji NATORI, Chino (JP); Kazuo TANAKA, Ina (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/124,313

(22) Filed: May 21, 2008

(30) Foreign Application Priority Data
May 22, 2007 (JP) 2007-135082
Jul. 18, 2007 (JP) 2007-186602

(51) Int. Cl. H04L 9/28

(52) U.S. Cl. 380/28

(57) ABSTRACT

A communication system includes: a transmission device; and a reception device, wherein the transmission device includes an encryption section that encrypts a plaintext to be transmitted to the reception device with a first encryption key, and a transmission section that transmits the encrypted plaintext to the reception device; and the reception device includes a FeRAM that stores a second encryption key to pair with the first encryption key, wherein, upon reading out the second encryption key from the FeRAM, the second encryption key is erased from the FeRAM, a reception section that receives the encrypted plaintext from the transmission device, and a decoding section that decodes the received plaintext encrypted with the first encryption key with the second encryption key that is supposed to be stored in the FeRAM.

The entire disclosure of Japanese Patent Application Nos: 2007-135082, filed May 22, 2007 and 2007-186602, filed Jul. 18, 2007 are expressly incorporated by reference herein.

### BACKGROUND

1. Technical Field

The present invention relates to communication systems and receiver devices.

2. Related Art

Cryptographic technology has been used to prevent leak of classified data. A variety of methods are available in cryptographic technology. When data is encrypted or decoded, encryption keys for controlling the procedure of encryption algorithm are required. For example, in the case of a communication system for vehicles described in JP-A-08-170457, encrypted data transmitted from a transmitter is received by a receiver mounted on a vehicle, and the encrypted data received is decoded by using an encryption key. In the case of communication systems in related art, for example, encryption keys may often be stored in an electrically rewritable nonvolatile memory, such as, for example, an EEPROM (electrically erasable programmable read-only memory), a flash memory or the like.

However, when encryption keys are stored in a nonvolatile memory, such as, an EEPROM, a flash memory or the like, as in the communication system in related art described above, unauthorized users with malicious intention may read the encryption keys. Then, a transmitter device may be counterfeited based on the encryption keys read out, and there is a possibility that the communication system may be illegally operated by the transmission device.

### SUMMARY

In accordance with an advantage of some aspects of the invention, a solution to at least a part of the problems described above can be provided.

In accordance with an embodiment of the invention, a communication system includes a transmission device and a reception device, wherein the transmission device includes an encryption section that encrypts a plaintext to be transmitted to the reception device with a first encryption key, and a transmission section that transmits the encrypted plaintext to the reception device; and the reception device includes a FeRAM that stores a second encryption key to pair with the first encryption key, wherein the second encryption key is erased from the FeRAM when the second encryption key is read out from the FeRAM, a reception section that receives the encrypted plaintext from the transmission device, and a decoding section that decodes the received plaintext encrypted with the first encryption key with the second encryption key that is supposed to be stored in the FeRAM.

According to the communication system described above, in the transmission device, the transmission section transmits to the reception device a plaintext encrypted by the encryption section with the first encryption key. In the reception device, the reception section receives the encrypted plaintext, and the decoding section decodes the encrypted plaintext with the second encryption key that pairs with the first encryption key. The second encryption key is stored in the FeRAM, and erased if it is read out from the FeRAM. As the second encryption key is erased when it is read out, the decoding section cannot decode an encrypted plaintext with the second encryption key after it is erased. Therefore, if an unauthorized user with malicious intention reads out the second encryption key, and illegally creates a transmission device having the first encryption key based on the second encryption key read out, an encrypted plaintext sent from the transmission device cannot be decoded by the reception device. Accordingly, the unauthorized user with malicious intention cannot illegally operate the reception device.

The communication system in accordance with an aspect of the invention may further include a control section that, after the second encryption key is read out from the FeRAM, controls not to perform rewriting to the FeRAM after the readout has taken place.

According to the communication system described above, when the second encryption key is read out from the FeRAM, the control section controls so as not to perform rewriting to the FeRAM. Accordingly, when the second encryption key is read out by unauthorized uses with malicious intention, the control section controls the FeRAM not to perform a rewriting operation, which places the content of the second encryption key in a state being destructively readout and erased.

In the communication system described above, the FeRAM may have 10¹⁰ times or more of writing/rewriting durability.

According to the communication system described above, the FeRAM has excellent rewriting durability, such that the communication system with the FeRAM that performs rewriting operations after destructive readout operations can be put in practical use.

In the communication system described above, the decoding section may be stored in the FeRAM.

According to the communication system described above, the decoding section is stored in the FeRAM, which makes it difficult for unauthorized users with malicious intention to analyze the algorithm of the decoding section to readout the encryption key.

In accordance with an embodiment of the invention, a reception device includes a FeRAM that stores an encryption key, wherein the encryption key is erased from the FeRAM when the encryption key is read out from the FeRAM, a reception section that receives an encrypted plaintext, and a decoding section that decodes the received encrypted plaintext with the encryption key that is supposed to be stored in the FeRAM.

According to the reception device, the reception section receives the encrypted plaintext, and the decoding section decodes the encrypted plaintext with the encryption key. The encryption key is stored in the FeRAM, and erased when read out from the FeRAM. As the encryption key is erased when it is read out, the decoding section cannot decode an encrypted plaintext with the encryption key after the encryption key is erased. Therefore, even when unauthorized users with malicious intention read out the encryption key, and illegally create a transmission device based on the encryption key read out, an encrypted plaintext sent from the transmission device cannot be decoded by the reception device. Accordingly, the unauthorized users with malicious intention cannot illegally operate the reception device.

### BRIEF DESCRIPTION OF THE DRAWINGS

FIG. 1 is a schematic illustration of an example of a communication system in accordance with an embodiment of the invention.

FIG. 2 is a block diagram of functional compositions of a reception device mounted on a vehicle and a remote control key.

FIG. 3 is a schematic diagram of a memory cell forming a FeRAM.

FIG. 4 is a flowchart of operations of the reception device and the remote control key.

### DESCRIPTION OF EXEMPLARY EMBODIMENTS

A communication system in accordance with an embodiment of the invention is described below with reference to the accompanying drawings.

Summary of Vehicle and Remote Control Key

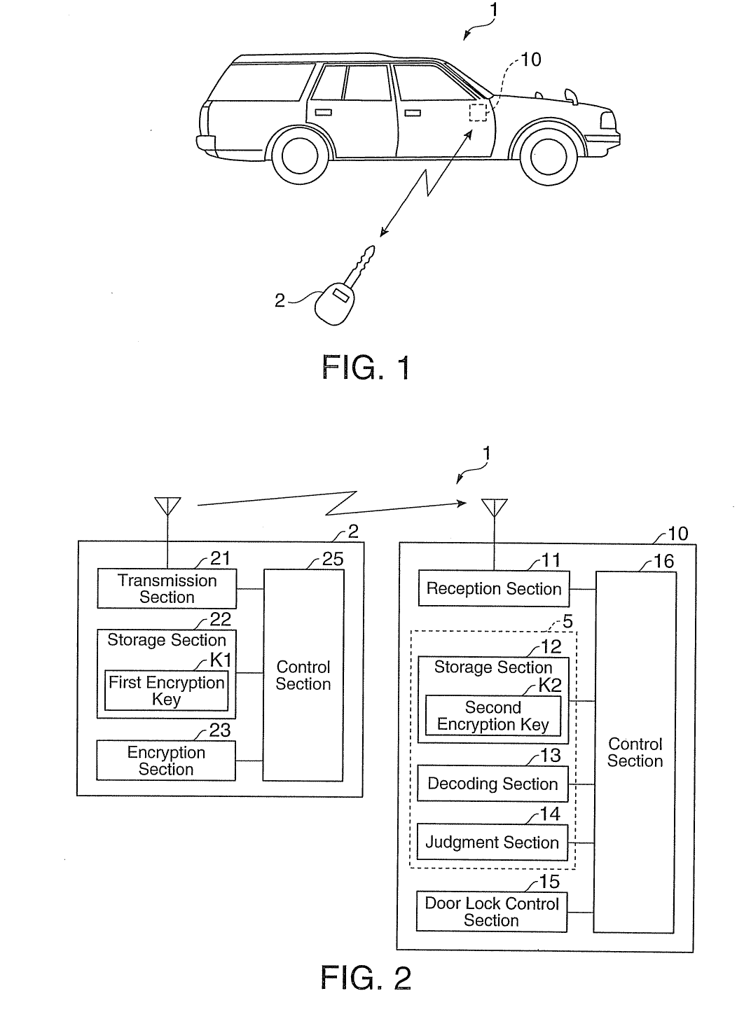

FIG. 1 is a schematic illustration of an example of a communication system in accordance with an embodiment of the invention. The communication system in accordance with the present embodiment is formed from a reception device 10 that is mounted on a vehicle 1, and a remote control key 2 that functions as a transmission device. The user holds the remote control key 2 and remotely controls the vehicle 1. The vehicle 1 is in a stopped state, and the engine on the vehicle 1 is also stopped.

Functional Structure of Reception Device and Remote Control Key

FIG. 2 is a block diagram of functional compositions of the reception device 10 installed on the vehicle 1 and the remote control key 2. As shown in the drawing, the reception device 10 includes a reception section 11, a storage section 12, a decoding section 13, a judgment section 14, a door lock control section 15, and a control section 16. The remote control key 2 includes a transmission section 21, a storage section 22, an encryption section 23 and a control section 25. The storage section 12 of the reception section 10 stores a second encryption key K2, and the storage section 22 of the remote control key 2 stores a first encryption key K1.

The storage section 12, the decoding section 13 and the judgment section 14 of the reception device 10 require rewriting and storing capability, and may be formed from a FeRAM (ferroelectric random access memory) 5 having tamper proofness. It is noted that not all of the storage section 12, the decoding section 13 and the judgment section 14 may be composed of a FeRAM 5, but at least the second encryption key K2 stored in the storage section 12 may be formed from the FeRAM 5. The FeRAM 5 shall be described in detail below.

Next, functions of the reception device 10 are described. The reception section 11 of the reception device 10 receives a signal on infrared ray or radio wave as command information. The command information includes encrypted identification information that identifies the remote control key 2, and control information that controls the vehicle 1.

The decoding section 13 of the reception device 10 uses the second encryption key K2 stored in the storage section 12, thereby decoding the encrypted identification information included in the command information received at the reception section 11.

The judgment section 14 of the reception device 10 judges, based on the identification information of the remote control key 2 decoded by the decoding section 13, as to whether the remote control key 2 can match with the reception device 10. Here, hash values of the decoded identification information of the remote control key 2 and the identification information stored in the ROM of the control section 16 (to be described below) are calculated, and the two hash values are compared to make the judgment.

The door lock control section 15 of the reception device 10 locks or unlocks the door lock of the vehicle 1 based on control information contained in the received instruction information when the judgment section 14 judges that the remote control key 2 can match.

The control section 16 of the reception device 10 is equipped with CPU, ROM, RAM and the like (not shown), and controls each of the aforementioned reception section 11, the storage section 12, the decoding section 13, the judgment section 14 and the door lock control section 15.

Next, functions of the remote control key 2 are described. The transmission section 21 of the remote control key 2 transmits to the vehicle 1 signals that define instruction information containing encrypted identification information and control information.

The encryption section 23 of the remote control key 2 encrypts identification information in a plaintext that identifies the remote control key 2, using the first encryption key K1 stored in the storage section 22. The first encryption key K1 pairs with the second encryption key K2 stored in the storage section 12 of the reception device 10, and the identification information encrypted with the first encryption key K1 can be decoded with the second encryption key K2. It is noted that a plaintext refers to information prior to encoding.

The control section 25 of the remote control key 2 is equipped with CPU, ROM, RAM and the like (not shown), and controls each of the aforementioned transmission section 21, the storage section 22 and the encryption section 23.

Identification information in a plaintext that identifies the remote control key 2 is stored in the ROM of the control section 25. Control information for controlling the vehicle 1 is generated by the control section 25 in response to operations of the operation buttons (not shown) and the like depressed by the user.

Structure of Storage Section

Next, the FeRAM 5 for the vehicle 1 is described. The FeRAM 5 is comprised of memory cells formed from ferroelectric material, and is a memory in which the ferroelectric material is used in capacitors for data retention. Here, the ferroelectric film has spontaneous polarization and has a property in which its polarization direction reverses according to the direction of an applied electric field. The FeRAM 5 uses the polarization inversion for memory retention. Also, the FeRAM 5 is a nonvolatile memory that does not require a power to retain data.

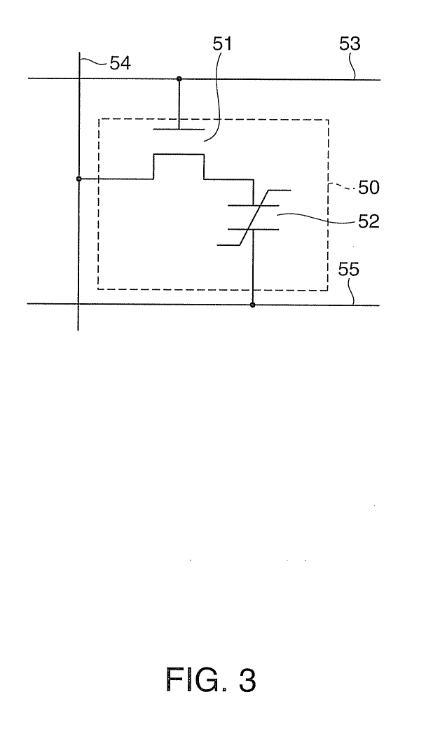

FIG. 3 shows a diagram of a memory cell 50 that forms the FeRAM 5. As illustrated, the memory cell 50 is comprised of a transistor 51 and a ferroelectric capacitor 52 formed from a ferroelectric film. The transistor 51 has a gate terminal connected to a word line (WL) 53, a drain terminal (or a source terminal) connected to a bit line (BL) 54, and a source terminal (or a drain terminal) connected to one of the terminals of the ferroelectric capacitor 52. The other terminal of the ferroelectric capacitor 52 is connected to a plate line (PL) 55.

Next, operations to write data to the memory cell 50 are described. When a predetermined voltage (Vcc) is applied across the two terminals of the ferroelectric capacitor 52, data “1” or “0” is written in the memory cell 50. For example, when the WL 53 is placed in a selection state (in which the transistor 51 is in ON state), the BL 54 is set at 0V, and Vcc is applied to the PL 55, data “0” is written in the memory cell 50. When Vcc is applied to the BL 54, and the PL 55 is set to 0V, data “1” is written in the memory cell 50. Also, the memory cell 50 continues retaining data written even when the WL 53 becomes a non-selection state (in which the transistor 51 is in OFF state).

Next, operations to read out data written in the memory cell 50 are described. The memory cell 50 is equipped with a sense amplifier circuit (not shown). When the BL 54 is set to an open state (0V), the WL 53 is set to a selection state, and Vcc is applied to the PL 55, a predetermined voltage is supplied through the BL 54 to the sense amplifier circuit. The sense amplifier circuit is supplied with different voltages according to the polarization state of the ferroelectric capacitor 52, and performs amplification based on each of the voltages. According to the voltage after amplification by the sense amplifier circuit, data “1” or “0” is read out from the memory cell 50.

When data “1” is readout in the data readout operation, the memory cell 50 performs a destructive readout operation through inverting the polarization of the ferroelectric capacitor 52 from the state of “1” to “0.” The memory cell 50 is controlled to perform a rewriting operation through rewriting data “1” again after the data “1” has been read out, for maintaining the polarization of the ferroelectric capacitor 52 in the state “1.” At this time, the memory cell 50 is controlled by the control section 16 of the reception device 10 such that the rewriting operation is to be performed only upon confirming that the normal procedure is secured after the destructive readout operation. Accordingly, if the second encryption key K2 stored in the storage section 12 of the FeRAM 5 has been read out from the FeRAM 5, the control section 16 does not perform a rewriting operation, as it cannot be confirmed if the normal procedure is secured. As a result, the second encryption key K2 remains in the state of being erased.

The FeRAM 5 performs rewriting operations after destructive readout operations, using a high-speed execution performance equivalent to that of an ordinary volatile memory (for example, SRAM, DRAM and the like). Furthermore, the FeRAM 5 has 10¹⁰ times or more of rewriting durability.

Operations of Reception Device and Remote Control Key

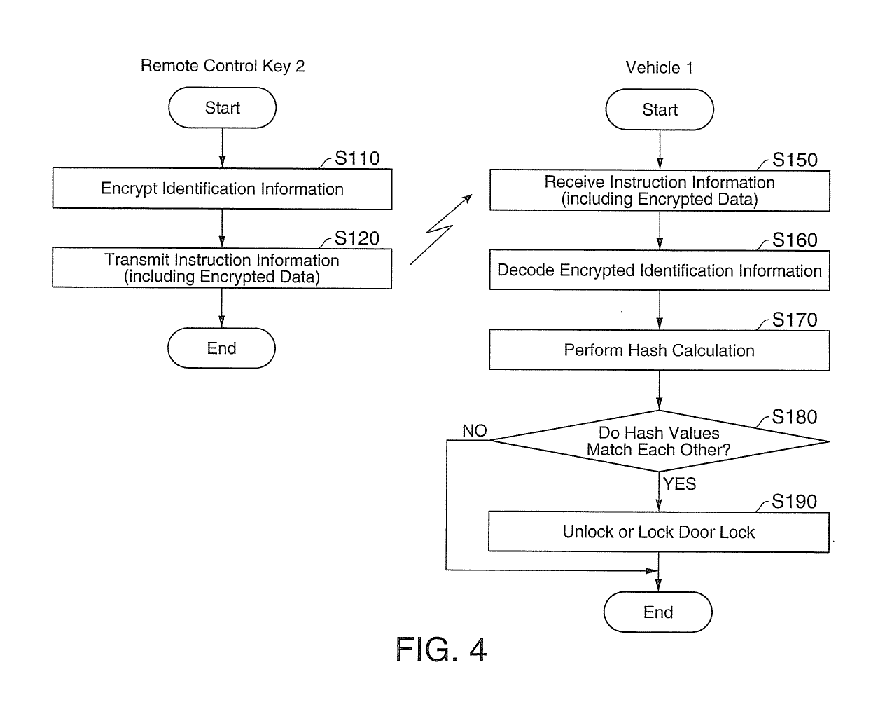

Next, operations of the reception device 10 and the remote control key 2 are described. FIG. 4 is a flowchart of operations of the reception device 10 mounted on the vehicle 1 and the remote control key 2.

First, when an operation button is operated by the user on the side of the remote control key 2 as illustrated, the encryption section 23 of the remote control key 2 encrypts the identification information for the remote control key 2, using the first encryption key K1 stored in the storage section 22, in step S110. The operation button may include two kinds of buttons, a vehicle door unlocking button and a vehicle door locking button.

In step S120, the transmission section 21 of the remote control key 2 transmits to the vehicle 1 instruction information containing the identification information encrypted in step S110 and control information that is generated according to the operation of the operation button.

Next, on the side of the vehicle 1, in step S150, the reception section 11 of the reception device 10 receives the instruction information transmitted from the remote control key 2.

In step S160, the decoding section 13 of the reception device 10 decodes the encrypted identification information contained in the instruction information received in step S150, using the second encryption key K2 stored in the storage section 12.

In step S170, the judgment section 14 of the reception device 10 calculates two hash values of the identification information of the remote control key 2 which is decoded in step S160 and the identification information stored in the ROM of the control section 16 of the reception device 10.

In step S180, the control section 16 of the reception device 10 judges as to whether the two hash values calculated in step S170 match each other. When the hash values match each other, in other words, when the remote control key 2 matches the reception device 10, step S190 is performed whereby the door lock control section 15 of the reception device 10 controls to unlock or lock the door lock of the vehicle 1. On the other hand, when the hash values do not match, in other words, when the remote control key 2 does not match the reception device 10, the process is finished without unlocking or locking the door lock.

Effects

As described above, according to the communication system in accordance with the present embodiment, the storage section 12, the decoding section 13 and the judgment section 14 of the reception device 10 are formed from the FeRAM 5. Also, the memory cell 50 forming the FeRAM 5 is controlled to perform a rewriting operation only upon confirming that the normal procedure is secured after a destructive readout operation. Therefore, if the second encryption key K2 stored in the storage section 12 is read out from the FeRAM 5, the second encryption key K2 assumes a state of being erased. Accordingly, even when an unauthorized user with malicious intention reads out the second encryption key K2 from the FeRAM 5, and illegally creates a remote control key having the first encryption key K1 based on the second encryption key K2, encrypted identification information sent from the remote control key cannot be decoded by the reception device 10. Accordingly, the unauthorized user with malicious intention cannot unlock or lock the door lock of the vehicle 1 by using the illegally created remote control key.

Also, the decoding section 13 and the judgment section 14 are also formed from the FeRAM 5, which makes it difficult for unauthorized users with malicious intention to analyze the algorithms for decoding process, judgment process and the like, and can improve the confidentiality concerning the encryption technology.

Also, the FeRAM 5 is capable of high-speed rewriting, and has 10¹⁰ times or more of rewriting durability. As a result, the quality guarantee in commercial and actual use can be secured for the communication system having the FeRAM 5 that performs a rewriting operation only upon confirming the correct procedure after a destructive readout operation.

It is noted that, in the embodiment described above, an example of a communication system formed from a reception device and a remote control key for a vehicle is described. However, the invention is not limited to the example, and is also applicable to various communication systems other than vehicle communication systems.

What is claimed is:

1. A communication system comprising: a transmission device; and a reception device, wherein
the transmission device includes an encryption section that encrypts a plaintext to be transmitted to the reception device with a first encryption key, and a transmission section that transmits the encrypted plaintext to the reception device; and
the reception device includes a FeRAM that stores a second encryption key to pair with the first encryption key, wherein the second encryption key is erased from the FeRAM when the second encryption key is read out from the FeRAM, a reception section that receives the encrypted plaintext from the transmission device, and a decoding section that decodes the received plaintext encrypted with the first encryption key with the second encryption key that is supposed to be stored in the FeRAM.

2. A communication system according to claim 1, further comprising a control section that controls such that the FeRAM does not perform a rewriting operation after the second encryption key has been read out from the FeRAM.

3. A communication system according to claim 1, wherein the FeRAM has 10¹⁰ times or more of rewriting durability.

4. A communication system according to claim 1, wherein the decoding section is stored in the FeRAM.

5. A reception device comprising:
a FeRAM that stores an encryption key, wherein the encryption key is erased from the FeRAM upon reading the encryption key out of the FeRAM;
a reception section that receives an encrypted plaintext; and
a decoding section that decodes the received encrypted plaintext with the encryption key that is supposed to be stored in the FeRAM.
